(19) United States
(12) Patent Application Publication
(10) Pub. No.: US 2022/0081115 A1
(43) Pub. Date: Mar. 17, 2022

(54) Neural prosthetic flying suit

(71) Applicant: Marcus Alan Sulger, Cochise, AZ (US)

(72) Inventor: Marcus Alan Sulger, Cochise, AZ (US)

(21) Appl. No.: 17/023,171

(22) Filed: Sep. 16, 2020

(51) Int. Cl. B64C 39/02; B64C 33/02; G06F 3/01

(52) U.S. Cl. CPC B64C 39/026; G06F 3/015; B64C 33/02

(57) ABSTRACT

A wearable flying suit is provided. The suit is in the form of a garment and associated helmet. The garment is form fitting and includes a number of attachments. A pair of pivotally attached wings are positioned on a rear back panel of the garment, the wings coupled to a source of motive power. The wings are made of a lightweight but durable material such as titanium, and are segmented into aerodynamically enhancing feathers. A battery pack is positioned within the garment, the battery pack receiving charge from a solar cell array positioned about the waistline of the garment.

### BACKGROUND OF THE INVENTION

### 1. Field of the Invention

The present invention generally relates to flying suits. More specifically, the invention relates to a flying suit that can function as a neural prosthetic.

### 2. Description of the Prior Art

Various types of flying suit to be worn by humans have been proposed in the prior art. These suits have been used with varying degrees of success.

U.S. Pat. No. 2,417,896 discloses a novel method of and apparatus for propelling a person through the air. The apparatus is, more particularly, of a type arranged to be worn by or applied to the person using the same, as distinguished from a vehicle, ship, machine or conveyance adapted to carry one.

United States Patent Application 2009002065 discloses a harness with mounted engine frame comprises a harness to be worn by a user. An engine support arm is mounted on the harness and a pair of lateral arms extend from the engine support arm. At least one engine is associated with each lateral arm. A connector attaches directly or indirectly to the harness for receiving the engine support arm, so that the engine support arm is movable relative to the harness in response to engine output and other flight conditions.

U.S. Pat. No. 3,023,980 discloses a turbo-fan powered harness that can be worn.

U.S. Pat. No. 7,182,295 discloses various methods, apparatuses, and systems in which an electric-energy lifting panel levitates a user secured to the electric-energy lifting panel. The electric-energy lifting panel includes a first capacitive plate and a second capacitive plate having different geometric dimensions to generate a net-directional force. An ion conditioner ion enhances air around the first capacitive plate and the second capacitive plate.

While these devices may be effective, they suffer from a number of drawbacks. First, the devices are usually in the form of a harness or like attachment means. If one or more buckles/straps, etc. comes loose, the user will inevitably spiral dangerously out of control. Secondly, the devices are either electrically powered or gas engine powered and are thus susceptible to running out of power/fuel. Finally, the device are operated by a series of levers, switches, or other actuators which require that a user learn how to manipulate the actuators before safely using the device. The learning curve is usually steep, and not every person is capable of mastering the required techniques.

None of the modifications described above, or otherwise known in the prior art provide an apparatus for personal flight which overcomes the above, and other, drawbacks.

A wearable flying suit is provided. The suit is in the form of a garment and associated helmet. The garment is form fitting and includes a number of attachments. A pair of pivotally attached wings are positioned on a rear back panel of the garment, the wings coupled to a source of motive power. The wings are made of a lightweight but durable material such as titanium, and are segmented into aerodynamically enhancing feathers. A battery pack is positioned within the garment, the battery pack receiving charge from a solar cell array positioned about the waistline of the garment.

### SUMMARY OF THE INVENTION

It is a major object of the invention to provide a flying suit.

It is another object of the invention to provide a flying suit that is powered by a neural prosthetic.

It is another object of the invention to provide a flying suit that is in the form of an entire garment.

It is another object of the invention to provide a flying suit that is at least partially powered by renewable energy.

### BRIEF DESCRIPTION OF THE DRAWINGS

FIG. 1 shows a front view of the inventive flying suit worn by a user.

FIG. 2 shows a rear view of the inventive flying suit worn by a user.

FIG. 3 shows a plan view of a helmet used with the inventive flying suit.

### DETAILED DESCRIPTION OF THE PREFERRED EMBODIMENTS

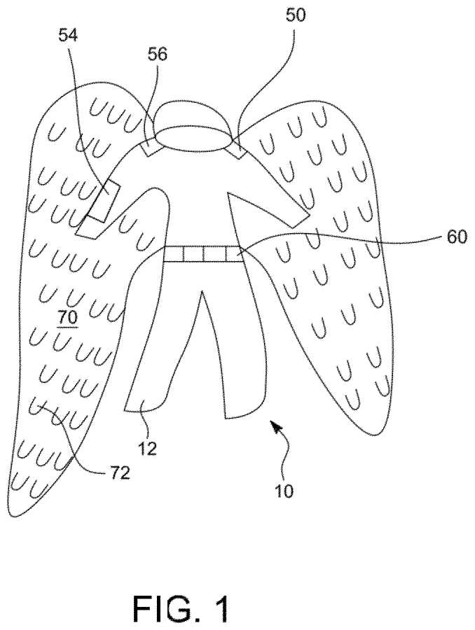

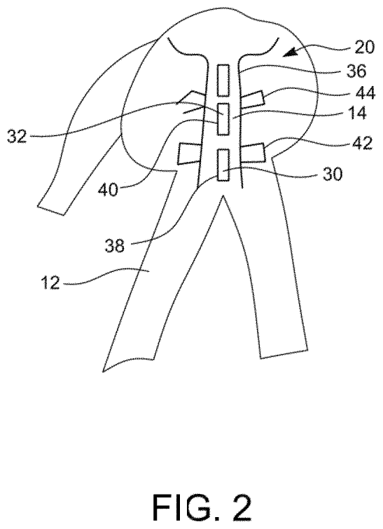

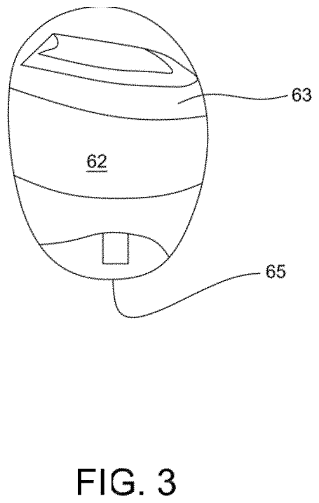

Referring now to FIGS. 1-3, illustrated therein is the assembly of the invention, generally indicated by the numeral 10. The invention is essentially a suit or garment 12 to which various attachments are added to assist in the act of flying. The garment 12 is preferably sized to fit a particular individual as it is made from titanium which is rigid. The garment is segmented and articulated to provide a full range of motion for the user. The garment 12 covers both the upper and lower body of the user. The rigid suit 12 includes a lining 13 made of carbon fiber, the lining may be in the form of a jumpsuit or a 2 piece undergarment and serves the purpose of preventing chafing or other discomfort that can result from metal directly in contact with skin.

The upper part 20 of the garment may be formed of front and rear halves 21, 23 which lock together. A motor 30 for actuating the wings is attached to the rear 23 half with a locking member 31 for locking halves 21, 23 together, the member serving to prevent unintentional separation of the halves which would effectively eject the user.

A motor housing 33 contains the motors 30, wiring, processors 32, and a reserve battery 34. The housing 33 includes an external sleeve 36 having a more or less semi-cylindrical cross section sized to accommodate a series of motors 30, gears 38, and levers 40. The sleeve 36 is generally parallel to and aligned with the users's spine as this is the center of gravity. The motors 30 work in synchronized fashion utilizing control signals from processor 50 which is attached to the garment 12. Alternatively, a specially sized pocket or enclosure for containing the processor 50 is sewn into the garment, the pocket having a closure.

A temperature control system module 54 is attached to and wired into the garment 12 for receiving electrical power and may include heating, cooling conduits, the unit battery powered. The system 54 may include sensors so as to automatically power the system 54 in response to a range of temperatures. A main battery 56 which is attached to the garment 12 supplies power to motor, temperature control system 54, and processor 50.

A solar belt 60, which may be supplemented by additional solar panels positioned on the garment, is used to charge main battery 56, the battery 56 electrically connected to all components of the suit 10 via internal wiring. The belt 60 is relatively wide to accommodate the solar panels 61, which panels may be secured by e.g., an adhesive.

A helmet 62 includes a neural array 63 which is used to sense electrical impulses from the user. Brain Computer Interfaces (BCIs) for sensing neural impulses are known in the art. An EEG (electroencephalography—EEG) sensor can be used as a BCI. EEG is a non-invasive approach that utilizes surface electrodes to detect brain activity through the scalp. Thus, neural array 63 may be of the EEG type as it does not require any surgical intervention. Helmet 62 may include its own battery source as well as receive charge from solar belt 60. As is known in the art, a person can think about motivation of a limb, and this can be translated into an electrical signal to initiate movement of a prosthetic limb, using the appropriate sensors and supporting apparatus. Likewise, a user can think about flapping or moving a wing, and have those thoughts translated into electrical signals for moving a wing using the well known techniques, the thoughts being sensed by neural array 63. The exact configuration of these types of systems is known in the art. Data and power connectivity with the wiring in harness 14 is by way of a terminal 65 to which the appropriate power and data cabling is connected.

The wings 70 are made of the lightest metal capable of handling the stresses of flight. Titanium is preferably used, the wings 70 segmented into feather like structures 72 to increase lift, the wings therefore approximating natural feathers aerodynamically.

In operation, once the user has put the garment 12 on the user may then put the helmet 62 on to commence wing 70 flapping using the process described above. Once off the ground, the wings 70 are under processor control so that flapping is done as efficiently as possible. If any problems are sensed such as low power, the processor will initiate a landing procedure which includes gradual slowing of the wings 70. GPS can be used to monitor the height and position of the user, and this data can be sent to a remote server. The remote server can be used to monitor the position of the user, and even send alert signals to the user if problems such as excessive altitude are sensed.

I claim:

1. A neural flying suit apparatus comprising:
a one piece garment for covering the upper and lower body of a user, said garment including a harness;
a motor for generating reciprocating motion, and a pair of wings coupled to said motor, said wings pivotable in response to said reciprocating motion, said motor contained within a portion of said harness;
a microprocessor for controlling said motor;
a helmet having neural sensing capability for converting thought into an electrical signal;
whereby said electrical signal and control signals from said microprocessor control the reciprocating motion of the motor.

2. The apparatus of claim 1 including a source of electrical power electrically connected to said motor, said microprocessor, and said helmet.

3. The apparatus of claim 1 wherein said garment includes a belt having one or more solar panels disposed thereon.

4. The apparatus of claim 1 wherein said microprocessor controls said motor when predetermined conditions are sensed.

5. The apparatus of claim 1 wherein said neural sensing capability is provided by an EEG sensor array.
